SEQUENCE LISTING (2 sequences)

SEQ ID NO: 1 - DNA, 15 bp, Artificial Sequence
  probe oligonucleotide
tgttctcttgtcttg

SEQ ID NO: 2 - DNA, 15 bp, Artificial Sequence
  target oligonucleotide
caagacaagagaaca

(19) United States
(12) Patent Application Publication
(10) Pub. No.: US 2005/0271557 A1
(43) Pub. Date: Dec. 8, 2005

(54) Microarray holding device

(76) Inventors: Hun-joo Lee, Seoul (KR); Nam Huh, Seoul (KR); Sang-hyun Paek, Seoul (KR); Chang-eun Yoo, Seoul (KR)

Correspondence Address: CANTOR COLBURN, LLP, 55 GRIFFIN ROAD SOUTH, BLOOMFIELD, CT, 06002, US

(21) Appl. No.: 11/106,209

(22) Filed: Apr. 14, 2005

(30) Foreign Application Priority Data
Jun. 2, 2004 (KR) 10-2004-0039981

(51) Int. Cl. B01L 9/00

(52) U.S. Cl. 422/104

(57) ABSTRACT

Provided is a microarray holding device. The microarray holding device includes: a solid substrate in the form of a plate in which an engaging-receiving portion for receiving a microarray substrate to be engaged therewith is formed, the engaging-receiving portion being composed of an opening; sidewalls to be aligned with sidewalls of the microarray substrate to be engaged with the engaging-receiving portion; and a base surface on which a top or bottom surface of the microarray substrate to be engaged with the engaging-receiving portion is to be placed, wherein the base surface is depressed from a top or bottom surface of the solid substrate such that the other surface of the microarray substrate is lower than the top or bottom surface of the solid substrate when the microarray substrate is engaged with the engaging-receiving portion.

### BACKGROUND OF THE INVENTION

This application claims the benefit of Korean Patent Application No. 10-2004-0039981, filed on Jun. 2, 2004, in the Korean Intellectual Property Office, the disclosure of which is incorporated herein in its entirety by reference.

1. Field of the Invention

The present invention relates to a microarray holding device.

2. Description of the Related Art

Microarrays have very small amounts of materials, such as purified DNA or proteins as small spots with a diameter of usually 100-200 microns, arranged on a solid substrate. Conventional microarrays have spot regions on which biomolecules or other compounds are immobilized and a region for dealing with said microarrays on a substrate. The spot region comprises spots of biomolecules or other compounds immobilized at specific positions. FIG. 1 is a view of a conventional microarray consisting of a spot region 100 and a dealing region 110. A separate unit for fixing the microarray has not been used.

However, in the convention microarray having the spot region and the dealing region on the substrate, the immobilized compounds and the substrate are exposed to the outside during use, dealing and transportation and thus, tend to suffer from defects or damage. When the microarray substrate is small, it is difficult to deal with the microarray and analyze the microarray using conventional analytical instruments. Further, it is difficult to select a material suitable for both the spot region and the dealing region. There is a limit reducing the size of the substrate since the dealing region is contained in the substrate. The positions of the immobilized compounds on the microarray cannot be easily identified in analysis.

U.S. Pat. No. 6,361,745 describes a microarray storage device which includes a cassette having top, bottom, and opposite sidewalls, with the front and rear of the cassette being open. The sidewalls are formed with a multiplicity of parallel rails spaced along the heights of the walls which define the compartments in the cassette for supporting a multiplicity of microarrays stacked. However, the microarray storage device is only used to store a multiplicity of microarrays and each microarray stored in the microarray storage device cannot be dealt with or analyzed. A method of analysis using a microarray includes spotting, hybridization, washing, and imaging processes. To perform the spotting, hybridization, washing, and imaging processes, each microarray stored in the microarray storage device should be removed from the microarray storage device.

Thus, there is a need for a microarray holding device which can store an individual microarray and be used in combination with the microarray during hybridization, washing, and imaging.

### SUMMARY OF THE INVENTION

The present invention provides a microarray holding device which can store an individual microarray and be used together with the microarray during the hybridization, washing, and imaging.

According to an aspect of the present invention, there is provided a microarray holding device, comprising: a solid substrate in the form of a plate in which an engaging-receiving portion for receiving a microarray substrate to be engaged therewith is formed, the engaging-receiving portion being composed of an opening; sidewalls to be aligned with sidewalls of the microarray substrate to be engaged with the engaging-receiving portion; and a base surface on which a top or bottom surface of the microarray substrate to be engaged with the engaging-receiving portion is to be placed, wherein the base surface is depressed from a top or bottom surface of the solid substrate such that the other surface of the microarray substrate is lower than the top or bottom surface of the solid substrate when the microarray substrate is engaged with the engaging-receiving portion.

### BRIEF DESCRIPTION OF THE DRAWINGS

The above and other features and advantages of the present invention will become more apparent by describing in detail exemplary embodiments thereof with reference to the attached drawings in which:

FIG. 1 is a view of a conventional microarray consisting of a spot region and a dealing region;

FIG. 2A is a view of a microarray holding device according to an embodiment of the present invention; and

FIG. 2B is a schematic view illustrating a process of fixing a microarray in the microarray holding device illustrated in FIG. 2A;

FIG. 3A is a view of a microarray holding device according to another embodiment of the present invention, in which an engaging-receiving portion has an opening in a base surface;

FIG. 3B is a schematic view illustrating a process of fixing a microarray in the microarray holding device illustrated in FIG. 3A;

FIG. 4A is a view of a microarray holding device according to still another embodiment of the present invention, in which an engaging-receiving portion has opposing sidewalls having grooves;

FIG. 4B is a schematic view illustrating a process of fixing a microarray in the microarray holding device illustrated in FIG. 4A;

FIG. 5A is a view of a microarray holding device according to yet another embodiment of the present invention, in which an engaging-receiving portion has opposing sidewalls having grooves and a rectangular-shaped opening in a base surface;

FIG. 5B is a view of a microarray holding device according to a further embodiment of the present invention, in which an engaging-receiving portion has opposing sidewalls having grooves and a U-shaped opening in a base surface;

FIG. 6A is a view of a microarray holding device according to a further embodiment of the present invention, in which an engaging-receiving portion has a base surface depressed from a bottom surface of a substrate and having a rectangular-shaped opening in the base surface;

FIG. 6B is a schematic view illustrating a process of fixing a microarray in the microarray holding device illustrated in FIG. 6A; and

FIGS. 7A through 7C illustrate the results of fluorescence intensities measured after hybridization with target nucleic acids on microarrays fixed in microarray holding devices according to embodiments of the present invention.

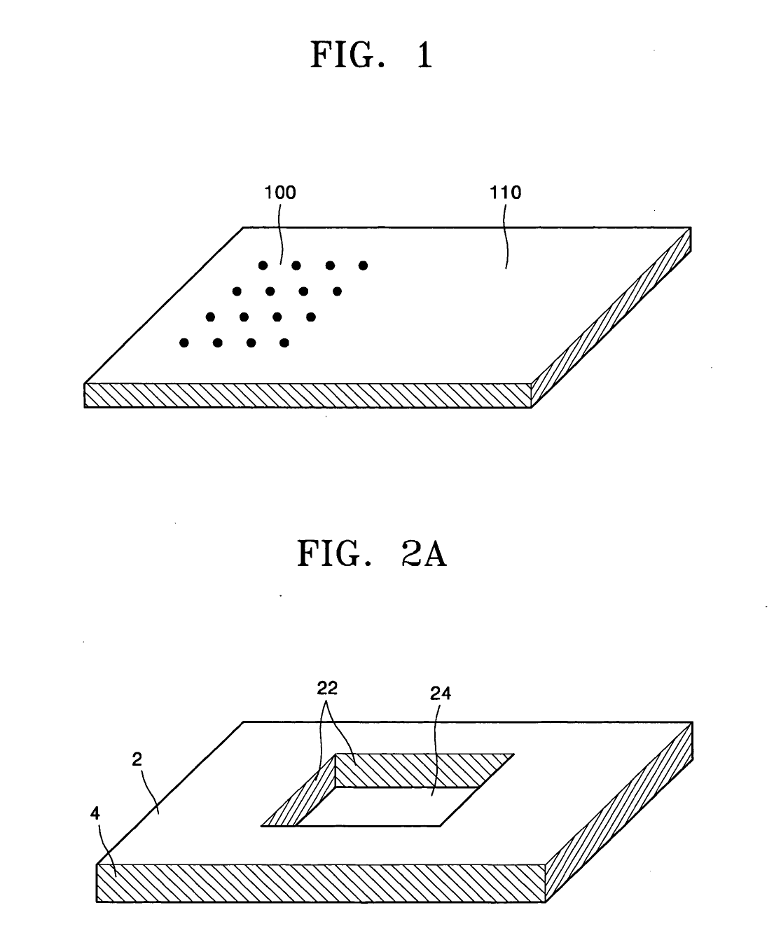

### DETAILED DESCRIPTION OF THE INVENTION

According to an aspect of the present invention, there is provided a microarray holding device, comprising:
a solid substrate in the form of a plate in which an engaging-receiving portion for receiving a microarray substrate to be engaged therewith is formed, the engaging-receiving portion being composed of
an opening;
sidewalls to be aligned with sidewalls of the microarray substrate to be engaged with the engaging-receiving portion; and
a base surface on which a top or bottom surface of the microarray substrate to be engaged with the engaging-receiving portion is to be placed,
wherein the base surface is depressed from a top or bottom surface of the solid substrate such that the other surface of the microarray substrate is lower than the top or bottom surface of the solid substrate when the microarray substrate is engaged with the engaging-receiving portion.

According to an exemplary embodiment of the present invention, the opening of engaging-receiving portion may be in the top surface of the solid substrate such that the bottom surface of the microarray substrate can contact the base surface of the engaging-receiving portion when the microarray substrate is inserted into the opening of the engaging-receiving portion in a direction from the top surface to the bottom surface of the solid substrate.

As used herein, the term “top surface of the microarray substrate” refers to a microarray surface on which biomolecules or other compounds are immobilized. As used herein, the term “bottom surface of the microarray substrate” refers to a surface opposite to the top surface of the microarray substrate. As used herein, the term “sidewalls of the microarray substrate” refers to surfaces defining the lateral sides of the microarray substrate. As used herein, the term “top surface of the solid substrate” refers to a surface which is aligned in the same direction as the top surface of the microarray substrate when the microarray substrate is engaged with the engaging-receiving portion. The top surface of the solid substrate is the main dealing portion in an analytical method using a microarray, etc. As used herein, the term “bottom surface of the solid substrate” refers to a surface which is aligned in the the same direction as the bottom surface of the microarray substrate when the microarray substrate is engaged with the engaging-receiving portion. The bottom surface of the solid substrate supports the microarray holding device.

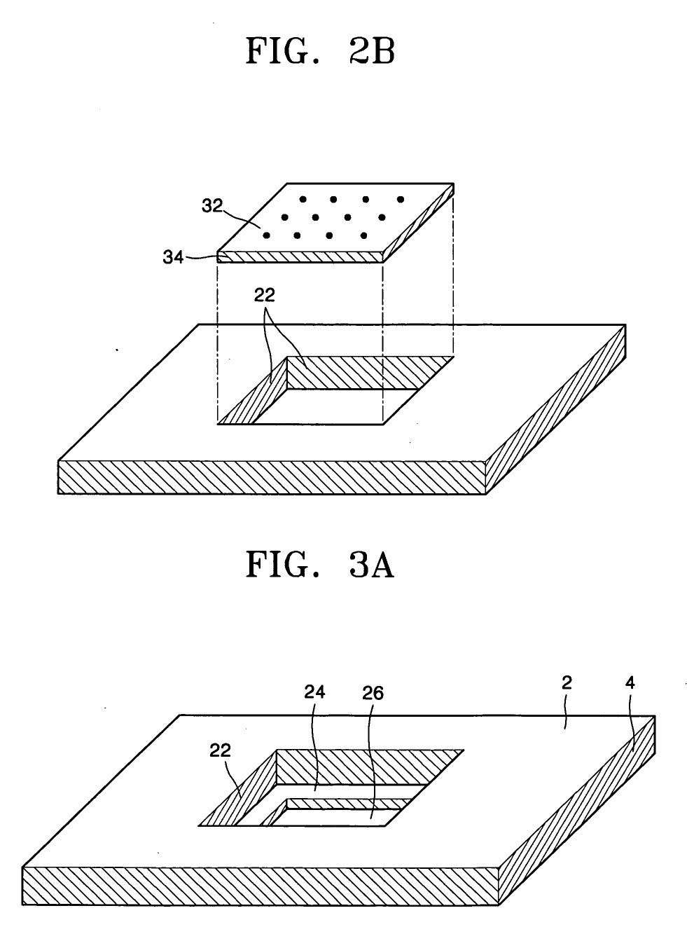

FIG. 2A is a view of a microarray holding device according to an embodiment of the present invention. Referring to FIG. 2A, the microarray holding device comprises a solid substrate in the form of a plate having two surfaces 2 and sidewalls 4 and an engaging-receiving portion having sidewalls 22 and a base surface 24 is formed on the solid substrate. FIG. 2B is a schematic view illustrating a process of fixing a microarray in the microarray holding device illustrated in FIG. 2A. Referring to FIG. 2B, a top surface 32 of the microarray is designed to be in parallel to the base surface 24 of the engaging-receiving portion and sidewalls 34 of the microarray are arranged to fit precisely with the sidewalls 22 of the engaging-receiving portion, and then, applied with pressure to fix the microarray substrate in the engaging-receiving portion. The microarray holding device can be dealt, transported, and used with the microarray fixed therein.

According to another exemplary aspect of the present invention, the base surface of the engaging-receiving portion may have an opening having a predetermined size such that a portion of a bottom surface of a microarray substrate is exposed through a portion of a bottom surface of the solid substrate when the microarray substrate is engaged with the engaging-receiving portion. The opening may have any shape and size, provided that the base surface can function as a flange for preventing the microarray substrate from passing from the top surface to the bottom surface of the solid substrate.

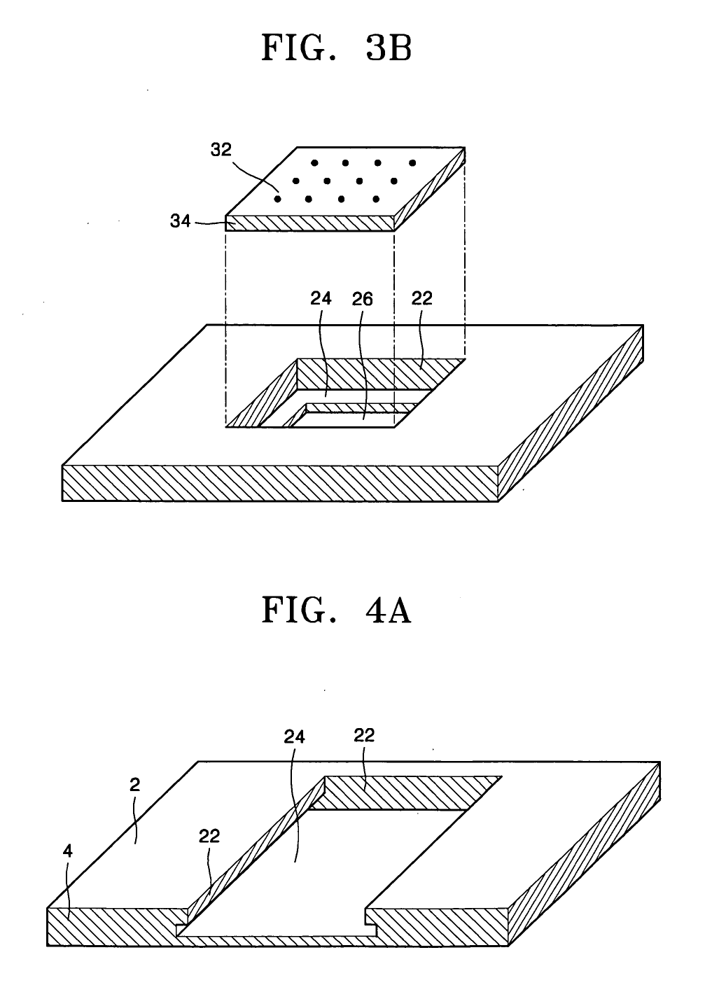

FIG. 3A is a view of a microarray holding device according to another embodiment of the present invention, in which an engaging-receiving portion has an opening in a base surface. Referring to FIG. 3A, the microarray holding device comprises a solid substrate in the form of a plate having two surfaces 2 and sidewalls 4 and an engaging-receiving portion having sidewalls 22 and a base surface 24, which has an opening 26, is formed on the solid substrate. FIG. 3B is a schematic view illustrating a process of fixing a microarray in the microarray holding device illustrated in FIG. 3A. Referring to FIG. 3B, a top surface 32 of the microarray is designed to be in parallel to the base surface 24 of the engaging-receiving portion and sidewalls 34 of the microarray are arranged to fit precisely with the sidewalls 22 of the engaging-receiving portion, and then, applied with pressure to fix the microarray substrate in the engaging-receiving portion. The microarray holding device can be dealt, transported, and used with the microarray fixed therein. Further, since the microarray holding device has the opening 26 in the bottom surface of the solid substrate, the microarray substrate can be treated, for example, by direct heating, through the bottom surface of the solid substrate.

According to still another exemplary aspect of the present invention, at least one sidewalls of a pair of opposing sidewalls of the engaging-receiving portion is open and both sidewalls of another pair of opposing sidewalls have grooves along which a microarray substrate slides so as to be engaged with the engaging-receiving portion. As used herein, the term “sidewall(s) of the engaging-receiving portion is(are) open” is intended to mean that when the microarray slides so as to be engaged with the engaging-receiving portion through grooves which are formed in two opposing sidewalls, a top surface of the microarray substrate on which biomolecules or other chemical compounds are immobilized is not interfered by the sidewall(s) present in a channel for the microarray. Thus, the term implies the case that the sidewall(s) is(are) not present in the channel, i.e., completely open, as well as the case that the sidewall(s) is(are) present in the channel and has(have) an opening such that the sidewall(s) cannot contact the compounds immobilized on the top surface of the microarray. The grooves may have a flange in any shape and size, provided that the flange does not contact the spots of the compounds immobilized on the top surface of the microarray substrate or does not adversely affect on the results of analysis using the microarray.

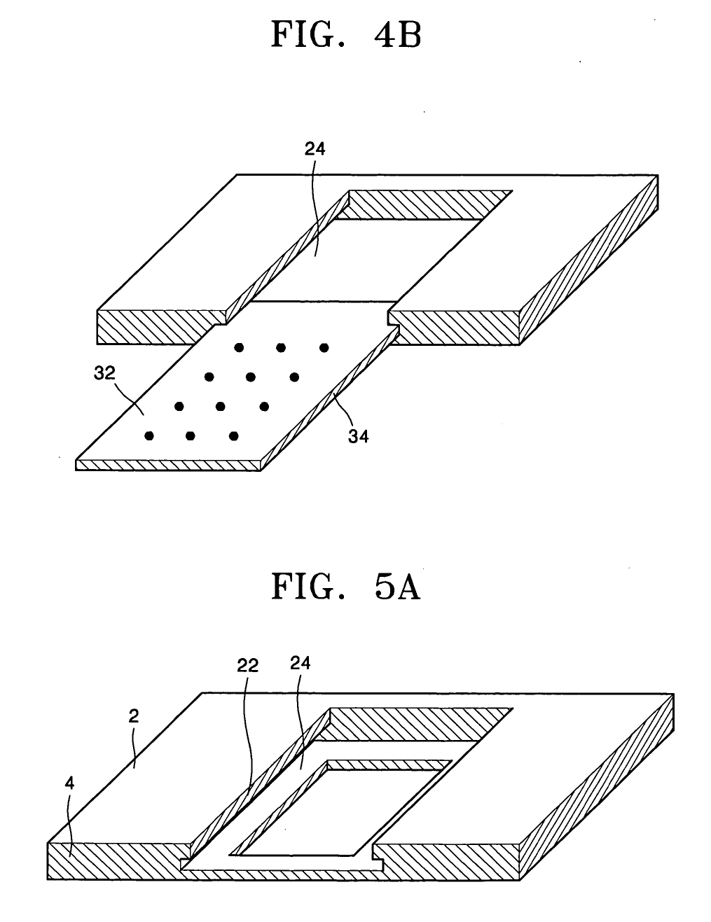

FIG. 4A is a view of a microarray holding device according to still another embodiment of the present invention, in which an engaging-receiving portion has opposing sidewalls having grooves. Referring to FIG. 4A, the microarray holding device comprises a solid substrate in the form of a plate having two surfaces 2 and sidewalls 4 and an engaging-receiving portion having three sidewalls 22, of which two opposing sidewalls 22 have grooves, an open sidewall, and a base surface 24. FIG. 4B is a schematic view illustrating a process of fixing a microarray in the microarray holding device illustrated in FIG. 4A. Referring to FIG. 4B, a top surface 32 of the microarray is designed to be in parallel to the base surface 24 of the engaging-receiving portion and the microarray is allowed to slide along the grooves formed on the two opposing sidewalls of the engaging-receiving portion from the open sidewall of the engaging-receiving portion by pressing, thereby fixing the microarray in the holding device. The microarray holding device can be dealt, transported, and used with the microarray fixed therein.

According to yet another exemplary aspect of the present invention, at least one sidewalls of a pair of opposing sidewalls of the engaging-receiving portion is open, both sidewalls of another pair of opposing sidewalls have grooves along which a microarray substrate slides so as to be engaged with the engaging-receiving portion, and a base surface of the engaging-receiving portion has an opening with a predetermined size such that a portion of a bottom surface of the solid substrate exposed a portion of a bottom surface of the microarray substrate when the microarray substrate is engaged with the engaging-receiving portion. The opening may have any shape and size, provided that the base surface can function as a flange for preventing the microarray substrate from passing from the top surface to the bottom surface of the solid substrate.

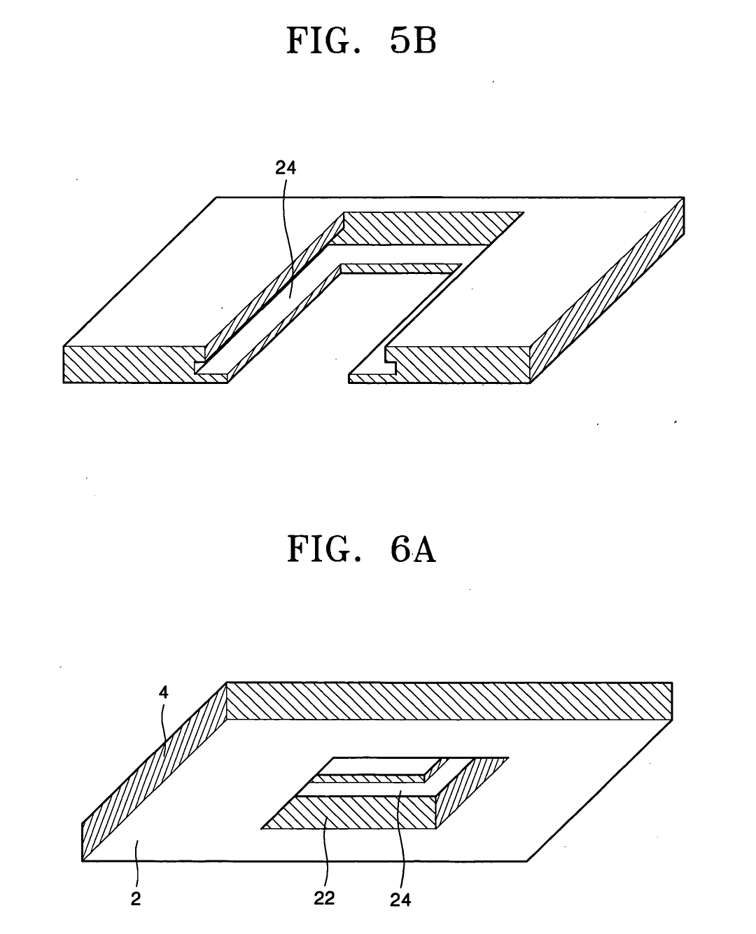

FIG. 5A is a view of a microarray holding device according to yet another embodiment of the present invention, in which an engaging-receiving portion has opposing sidewalls having grooves and an opening in a base surface. Referring to FIG. 5A, the microarray holding device comprises a solid substrate in the form of a plate having two surfaces 2 and sidewalls 4 and an engaging-receiving portion having three sidewalls 22, of which two opposing sidewalls 22 have grooves, an open sidewall, and a base surface 24 which has an opening 26 (not listed in 5B), is formed on the solid substrate. FIG. 5B is a view of a microarray holding device according to a further embodiment of the present invention, in which an engaging-receiving portion has opposing sidewalls having grooves and an opening in a base surface. Referring to FIG. 5B, a sidewall of the opening in the base surface 24 is open. The microarray holding device can be dealt, transported, and used with the microarray fixed therein. Further, since the microarray holding device also has an opening in the bottom surface of the solid substrate, the microarray substrate can be treated, for example, by direct heating, through the bottom surface of the solid substrate.

According to a further exemplary aspect of the present invention, the opening of the engaging-receiving portion may be in the bottom surface of the solid substrate such that the top surface of the microarray substrate can contact the base surface of the engaging-receiving portion when the microarray substrate is inserted into the opening of the engaging-receiving portion in a direction from the bottom surface to the top surface of the solid substrate and the top surface of the solid substrate has an opening having a predetermined size such that the top surface of the microarray substrate is exposed through a portion of the top surface of the solid substrate when the microarray substrate is engaged with the engaging-receiving portion. The opening may have any shape and size provided that the base surface can function as a flange for preventing the microarray substrate from passing from the bottom surface to the top surface of the solid substrate.

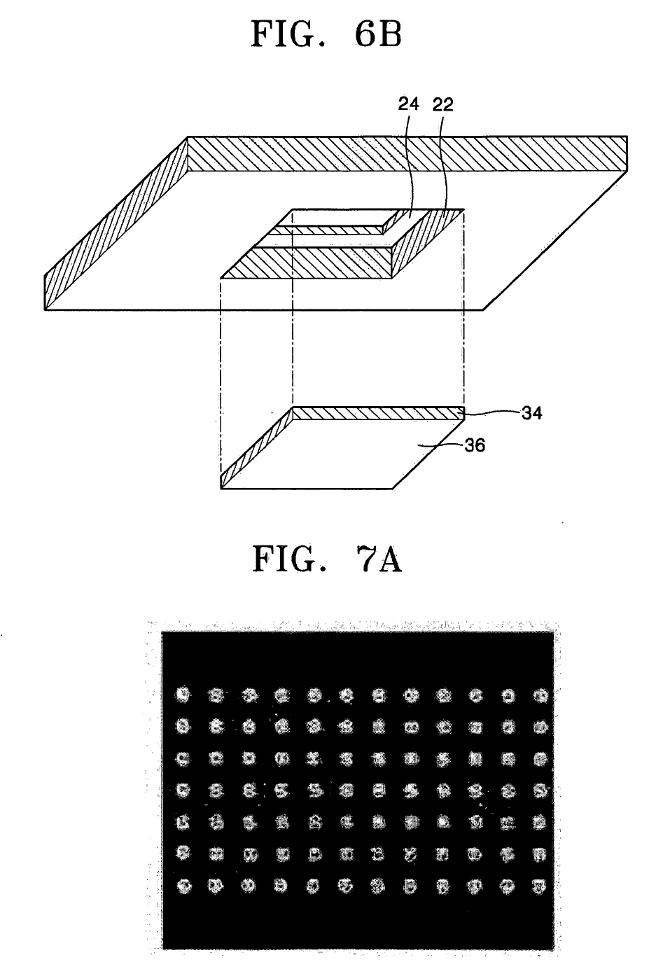

FIG. 6A is a view of a microarray holding device according to a further embodiment of the present invention, in which an engaging-receiving portion has a base surface depressed from a bottom surface of a substrate and having an opening. Referring to FIG. 6A, the microarray holding device comprises a solid substrate in the form of a plate having two surfaces 2 and sidewalls 4 and an engaging-receiving portion having sidewalls 22 and a base surface 24, which has an opening, is formed on the solid substrate. FIG. 6B is a schematic view illustrating a process of fixing a microarray in the microarray holding device illustrated in FIG. 6A. Referring to FIG. 6B, a top surface 32 of the microarray is arranged opposite to the base surface 24 of the engaging-receiving portion and sidewalls 34 of the microarray are arranged to fit precisely with the sidewalls 22 of the engaging-receiving portion, and then, a bottom surface 36 of the microarray substrate is applied with pressure to fix the microarray substrate in the engaging-receiving portion. The heights of the sidewalls 34 of the microarray substrate are shorter than those of the sidewalls 22 of the engaging-receiving portion, and thus, the bottom surface 36 of the microarray substrate engaged with the engaging-receiving portion is depressed from the bottom surface of the solid substrate. The microarray holding device can be dealt, transported, and used with the microarray fixed therein. Further, since the microarray holding device has the opening in the bottom surface of the solid substrate, the microarray substrate can be treated, for example, by direct heating, through the bottom surface of the solid substrate.

Although a material for the microarray holding device is not specifically limited, it is preferably a material which does not interfere with the detection of an optical signal in an analytical method using a microarray. Examples of the material include, but are not limited to, plastics, such as polycarbonate, polystyrene, polyacrylate, polyester, polyolefin, and mixtures thereof, and metals, such as aluminum and SUS. More specific examples include, but are not limited to, PMMA (polymethylmethacrylate), ABS (acrylonitrile butadiene styrene), POM (polyoxymethylene), aluminum, and polyethylene. These materials are well known in the art of manufacturing a microarray and commercially available or may be produced by those of ordinary skill in the art.

The microarray holding device may further comprise jig-combining portions to which jigs of an analytical instrument are combined, such that the microarray holding device with the microarray fixed therein can be used in a detection process in an analytical method using a microarray, in addition to the engaging-receiving portion. The jigs ensure that the microarray is disposed in the same position based on the analytical instrument. The jigs may have any shape and size as long as they can characterize the position the microarray in the microarray holding device. For example, the jigs may be three grooves disposed at separate predetermined positions based on the microarray. An identifier or a trademark, etc. can be engraved on the microarray holding device.

Hereinafter, the present invention will be described in more detail with reference to the following examples. However, these examples are given for the purpose of illustration and are not intended to limit the scope of the invention.

### EXAMPLES

### Example 1

Selection of a Material for a Microarray Holding Device

In Example 1, the effects of various materials for the microarray holding device according to an embodiment of the present invention on the results of a detection in an optical analytical method using a microarray were examined.

First, a probe oligonucleotide (SEQ ID No. 1) was immobilized on a silicon substrate having an amino functional group on its surface using a spotting method to produce a DNA microarray. The obtained microarray was fixed in the microarray holding device (1×1 in) illustrated in FIG. 2A. Then, the microarray was dipped in a 25% formamide SSPET hybridization buffer containing a target oligonucleotide (SEQ ID No. 2) labelled with Cy-3 and the hybridisation reaction was performed at 42° C. for 16 hours. After the hybridization reaction, the microarray was washed and irradiated at 532 nm using a scanner, and then a signal generated from the hybridization product was measured. A microarray having a spot region and a dealing region on a silicon substrate and having the same size as the microarray holding device was used as a control. The fluorescence intensities in a background region of the microarrays fixed in the microarray holding devices made of various materials and the control microarray are shown in the following table.

| | Control | PMMA | ABS | POM | Aluminum | Polyethylene |
|---|---|---|---|---|---|---|
| Average | 57.8 | 59.2 | 54.5 | 57.8 | 54.7 | 55.8 |
| Variance | 3.1 | 2.9 | 3.0 | 3.2 | 3.3 | 2.7 |

As listed in the above table, although the hybridization and washing processes were performed on the microarrays together with materials of PMMA, ABS, POM, aluminum, and polyethylene, the fluorescence intensities of the microarrays were not significantly different from the fluorescence intensity of the control microarray. Thus, it was confirmed that PMMA, ABS, POM, aluminum, and polyethylene are suitable materials for the microarray holding device according to an embodiment of the present invention.

### Example 2

Fixing of a Microarray Smaller than a Slide Glass, Using a Microarray Holding Device Having Jig-Combining Portions

In conventional microarray detectors, a horizontal level of a microarray is controlled by combining the microarray with jigs which are designed to be suitable for a size of a slide glass (1×3 in). The horizontal level of a microarray smaller than the slide glass cannot be easily controlled using such jigs, and thus, errors occur in the measuring of the fluorescence intensities. In Example 2, it was examined whether the fluorescence intensity of the microarray smaller than the slid glass can be accurately measured using the microarray holding device according to an embodiment of the present invention.

For this examination, a probe oligonucleotide (SEQ ID No. 1) was immobilized on substrates having the sizes of 2.54 cm×2.54 cm, 2.54 cm×2.54 cm, and 1 cm×1 cm, respectively, to produce DNA microarrays. The obtained microarrays were respectively fixed in the microarray holding device having the engaging-receiving portion which has the sidewalls and the base surface and is depressed from the top surface of the substrate, illustrated in FIG. 2A (1×2 in) (A), the microarray holding device having the engaging-receiving portion which has grooves along which the microarray slides and has the opening, illustrated in FIG. 5A (1×1 in) (B), and the microarray holding device having the engaging-receiving portion which has the sidewalls and the base surface and is depressed from the bottom surface of the substrate, illustrated in FIG. 6A (1×3 in) (C). The respective microarray holding devices have jig-combining portions having the same horizontal levels to the microarrays such that jigs of the detector can combine the microarrays to the microarray holding devices at the same levels. Next, the microarrays were dipped in a 25% formamide SSPET hybridization buffer containing a target oligonucleotide (SEQ ID No. 2) labelled with Cy-3, and then the hybridisation reaction was performed at 42° C. for 16 hours. After the hybridization reaction, the microarrays were washed and irradiated at 532 nm using a scanner, GenePix 4000B (manufactured by Axon). Finally, signals generated from the hybridization products were measured. A microarray having a spot region and a dealing region on a silicon substrate and having the same size as the microarray holding device was used as a control.

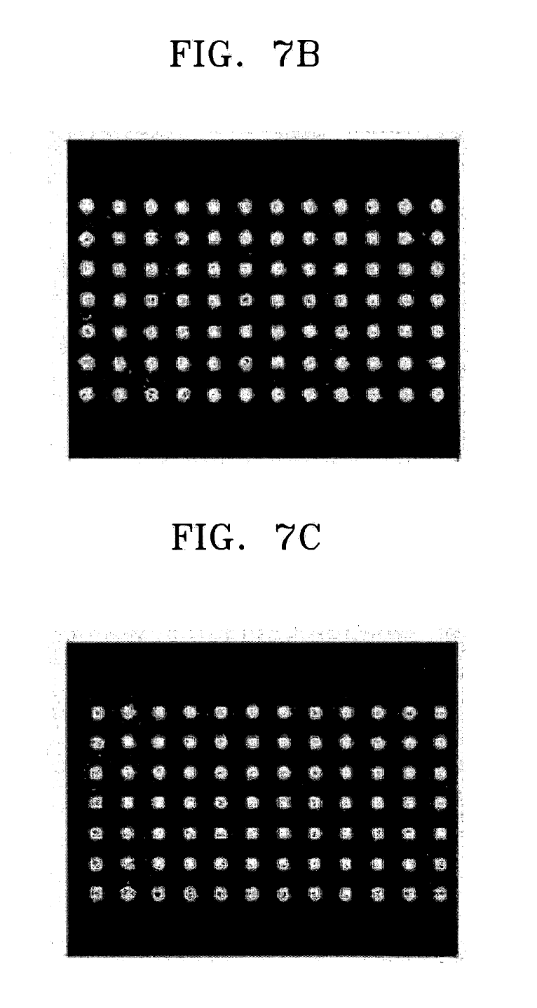

The variance of the fluorescence intensity measured on the control was 4.21 and variances of the fluorescence intensities measured the micrbarray holding devices A, B, and C were 5.44, 3.79, and 2.01, respectively. That is, there are no significant differences between the variance of the control and the variances of the devices A, B, and C. Fluorescences in the spot regions in the microarrays fixed in the devices A, B, and C were clearly detected. The results are shown in FIGS. 7A through 7C. FIGS. 7A through 7C illustrate the results of fluorescence intensities measured after hybridization with target nucleic acids on microarrays fixed on a microarray holding device according to an embodiment of the present invention.

It was confirmed that by using the microarray holding devices according to the embodiments of the present invention, the experimental data on the microarray smaller than the slide glass can be obtained without a large deviation.

The microarray holding device according to the present invention can fix a microarray and be dealt, used and transported with the microarray fixed therein.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A microarray holding device, comprising:
a solid substrate in the form of a plate in which an engaging-receiving portion for receiving a microarray substrate to be engaged therewith is formed, the engaging-receiving portion comprising:
an opening;
sidewalls to be aligned with sidewalls of the microarray substrate to be engaged with the engaging-receiving portion; and
a base surface on which a top or bottom surface of the microarray substrate to be engaged with the engaging-receiving portion is to be placed,
wherein the base surface is depressed from a top or bottom surface of the solid substrate such that the other surface of the microarray substrate is lower than the top or bottom surface of the solid substrate when the microarray substrate is engaged with the engaging-receiving portion.

2. The microarray holding device of claim 1, wherein the opening of the engaging-receiving portion is in the top surface of the solid substrate such that the bottom surface of the microarray substrate can contact the base surface of the engaging-receiving portion when the microarray substrate is inserted into the opening of the engaging-receiving portion in a direction from the top surface to the bottom surface of the solid substrate.

3. The microarray holding device of claim 2, wherein the base surface of the engaging-receiving portion has an opening having a predetermined size such that a portion of the bottom surface of the microarray substrate is exposed through a portion of the bottom surface of the solid substrate when the microarray substrate is engaged with the engaging-receiving portion.

4. The microarray holding device of claim 1, wherein at least one sidewall of a pair of opposing sidewalls of the engaging-receiving portion is open and both sidewalls of another pair of opposing sidewalls have grooves along which the microarray substrate slides so as to be engaged with the engaging-receiving portion.

5. The microarray holding device of claim 4, wherein the base surface of the engaging-receiving portion has an opening having a predetermined size such that a portion of the bottom surface of the microarray substrate is exposed through a portion of the bottom surface of the solid substrate when the microarray substrate is engaged with the engaging-receiving portion.

6. The microarray holding device of claim 1, wherein the opening of the engaging-receiving portion is in the bottom surface of the solid substrate such that the top surface of the microarray substrate can contact the base surface of the engaging-receiving portion when the microarray substrate is inserted into the opening of the engaging-receiving portion in a direction from the bottom surface to the top surface of the solid substrate and the top surface of the solid substrate has an opening having a predetermined size such that the top surface of the microarray substrate is exposed through a portion of the top surface of the solid substrate when the microarray substrate is engaged with the engaging-receiving portion.

7. The microarray holding device of claim 1, wherein the bottom surface of the solid substrate has three holes at predetermined positions, to which jigs of an analytical instrument can be combined.
